(19) United States
(12) Patent Application Publication
(10) Pub. No.: US 2015/0083785 A1
(43) Pub. Date: Mar. 26, 2015

(54) PURGING DEVICE FOR PIPE WELDING

(71) Applicant: Jin Woo Park, Incheon (KR)

(72) Inventor: Jin Woo Park, Incheon (KR)

(21) Appl. No.: 14/381,217

(22) PCT Filed: Jan. 23, 2013
(86) PCT No.: PCT/KR2013/000524

§ 371 Date: Aug. 27, 2014

(30) Foreign Application Priority Data
Mar. 7, 2012 (KR) 10-2012-0023302

(51) Int. Cl. B23K 37/00; B23K 9/16

(52) U.S. Cl. CPC B23K 37/00; B23K 9/16; B23K 2201/10
USPC 228/33

(57) ABSTRACT

Disclosed is a purging device for pipe welding, comprising: a pair of sealing tools that are disposed inside a pipe, expand by supplied air and are in contact with an inner wall of the pipe; and a connection pipe that is disposed between the pair of sealing tools, is a cylindrical body, wherein the sealing tools are respectively fixed to either side end of the connection pipe and the connection pipe is provided with a gas nozzle for discharging inert gas supplied from the outside, wherein each of the sealing tools further comprises a blocking layer that is flame retardant and is coupled in such a manner as to surround an outer circumferential surface of each of the sealing tools.

### TECHNICAL FIELD

The present invention relates to a purging device for pipe welding, and more particularly, to a purging device for pipe welding which is capable of preventing a purging device disposed inside a pipe from being damaged by heat generated during welding.

### BACKGROUND ART

A purging operation is an operation in which a blocking layer is formed at one end of each of the pipes to be welded so as to prevent oxidation of welding beads and to obtain quality of welding when the pipes are welded and joined together and the pipes to be welded are fixed to face one another so that portions to be welded are in contact with one another and then the portions to be welded are taped and sealed and then an inert gas, such as argon (Ar), is injected into the pipe so as to prevent oxidation of the welding beads.

After the purging operation is performed, the blocking layer is removed, and the Ar gas injected into the pipe is removed, and a worker enters an inside of the pipe and visually checks a state of back beads of the welded pipes.

The purging operation requires a large amount of time and workforce when necessary work for pipe welding is performed or the blocking layer is formed and removed so as to prevent oxidation of the beads and to obtain quality of welding during welding. In particular, when a length of the pipe is large, more effort is required to form and remove the blocking layer, and the injection quantity and injection time of the Ar gas to be injected into the pipe are increased.

Also, when the worker enters the inside of the pipe and checks the welded portions, there is a possibility that a secondary accident will occur due to the Ar gas that remains in the pipe, and in particular, a low oxygen concentration may be fatal to the worker.

Thus, there is Korean Patent Registration No. 10-0972654 (registered on Jul. 21, 2010) as suggested conventional art so as to solve the problems. In the conventional art, a distance between blocking layers disposed inside a pipe is reduced, and simultaneously, an Ar gas that remains in the pipe after welding is removed such that a danger of a working environment can be reduced.

However, in the conventional art, left and right air bags disposed inside the pipe may be damaged by heat generated during welding.

That is, the left and right air bags that are inserted into the pipe and then expanded using air supplied via an air supplying and exhausting portion may be damaged by heat generated during welding. Thus, the welding work is stopped, and the damaged air bags are removed and then need to be replaced with additional air bags.

### DISCLOSURE

### Technical Problem

The present invention is directed to providing a purging device for pipe welding, which includes a blocking layer that is coupled to a pair of sealing tools in such a manner as to surround an outer circumferential surface of each of the pair of sealing tools so that the pair of sealing tools that are disposed inside a pipe, expand using air supplied thereto and are in contact with an inner wall of the pipe, can be prevented from being easily damaged by heat generated during welding.

The present invention is also directed to providing a purging device for pipe welding that is formed of a nonflammable material so as to prevent a gas controlling portion that is disposed between the sealing tools and supplies and discharges an inert gas, such as Argon (Ar), from being damaged by heat generated during welding.

### Technical Solution

One aspect of the present invention provides a purging device for pipe welding, including: a pair of sealing tools that are disposed inside a pipe, expand by supplied air and are in contact with an inner wall of the pipe; and a connection pipe that is disposed between the pair of sealing tools, is a cylindrical body, wherein the sealing tools are respectively fixed to either side end of the connection pipe and the connection pipe is provided with a gas nozzle for discharging inert gas supplied from the outside, wherein each of the sealing tools further includes a blocking layer that is flame retardant and is coupled in such a manner as to surround an outer circumferential surface of each of the sealing tools.

The flame retardant blocking layer may be formed of a flame retardant fiber which has elasticity and in which heat transferred from the outside is not easily propagated, so that the flame retardant blocking layer stretches simultaneously with the sealing tools that expand by supply of air.

The flame retardant blocking layer may be formed of Kevlar having a minimum limiting oxygen index (LOI) of 27 or more.

The flame retardant blocking layer may include an opening in which one side of the flame retardant blocking layer is opened, and an elastic string formed of an elastic material along an outer circumferential surface of the opening.

The connection pipe may further include a cover formed of asbestos having a nonflammable property so as to prevent the sealing tools from being damaged by heat generated during pipe welding.

The connection pipe may further include a discharge hole through which the inert gas supplied is discharged to the outside.

### Advantageous Effects

As described above, in a purging device for pipe welding according to an exemplary embodiment of the present invention, a pair of sealing tools and a gas controlling portion are protected and can be prevented from being damaged by heat generated during pipe welding, and flame retardant blocking layers are detachably coupled to the sealing tools so that a flame retardant blocking layer damaged during usage can be easily replaced with another one, and the gas controlling portion is formed of asbestos having a nonflammable property, or a cover formed of asbestos is detachably coupled to a pipe body that constitutes the gas controlling portion so that maintenance can be facilitated.

### DESCRIPTION OF DRAWINGS

FIG. 1 is a view of a purging device according to the related art.

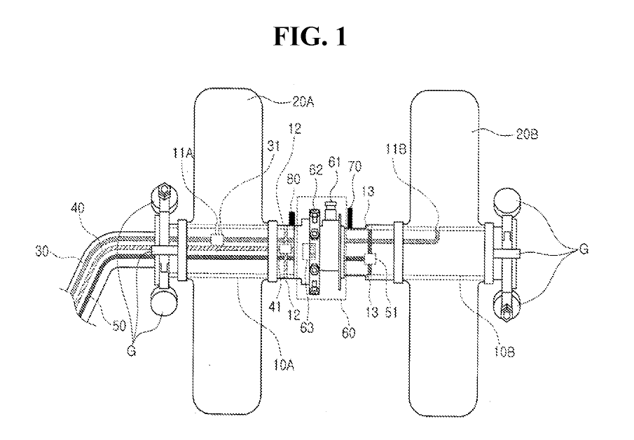

FIG. 2 is a perspective view of a purging device for pipe welding according to an exemplary embodiment of the present invention.

FIG. 3 is an exploded perspective view of the purging device for pipe welding illustrated in FIG. 2.

FIG. 4 is a view of a usage state of the purging device for pipe welding of FIG. 2.

[Explanation of Reference Numerals]

| | | |
|---|---|---|
| 1: purging device | P: pipe | |
| 10: sealing tool | | |
| 20: connection pipe | 22: gas nozzle | |
| 23: gas tank | 24: cover | |
| 30: air controlling portion | 31: air supplying pipe | 32: air nozzle |
| 33: air tank | 34: regulating portion | |
| 50: flame retardant blocking | 51: opening | 52: elastic string |
| layer | | |

### MODES OF THE INVENTION

Hereinafter, a purging device for pipe welding according to exemplary embodiments of the present invention will be described in detail with reference to the accompanying drawings. In the description of the present invention, if it is determined that a detailed description of well-known configuration or functions related to the invention is obvious to one of ordinary skill in the art, the detailed description will be omitted.

Also, same elements used in different positions in the following description are represented by the same reference numerals.

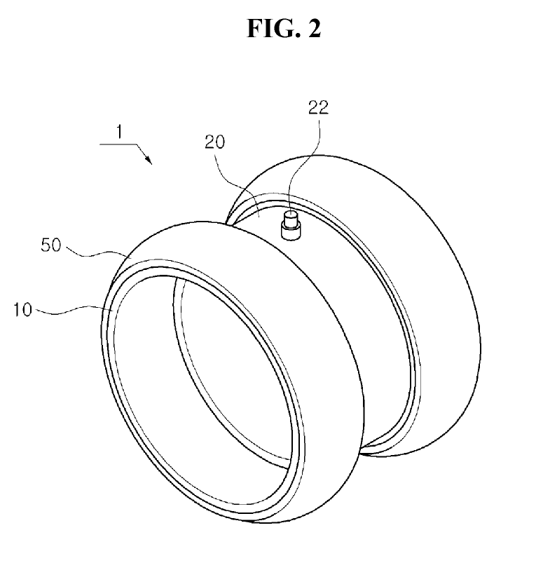

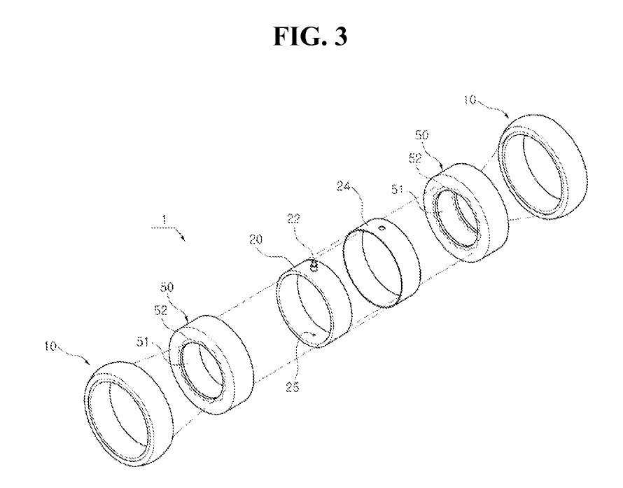

As illustrated in FIGS. 2 through 4, a purging device 1 for pipe welding according to an exemplary embodiment of the present invention includes a sealing tool 10, a connection pipe 20, and an air controlling portion 30. The sealing tool 10 further includes a flame retardant blocking layer 50.

The sealing tool 10 is inserted into right and left sides of a portion inside a pipe P to be welded expands using air supplied via the air controlling portion 30 that will be described later, contacts an inner wall of the pipe P and seals the portion to be welded. A pair of sealing tools 10 are provided to be spaced apart by a predetermined gap, are disposed at right and left sides of a portion in which the pipe P is to be welded, are expanded when air supplied via the air controlling portion 30 that will be described later is discharged through air nozzles 32, are in close contact with the inner wall of the pipe P in the expanded state, and seal the portion in which the pipe P is to be welded, from the outside.

In this case, the sealing tools 10 may be formed of a material having elasticity, such as urethane or rubber, so that the sealing tools 10 expand using the supplied air. An outer circumferential surface of each of the sealing tools 10 having the expanded shape may have a circular shape so that the sealing tools 10 may be in close contact with the inner wall of the pipe P. As illustrated in the drawings, the sealing tools 10 may have a cylindrical shape.

The connection pipe 20 discharges an inert gas, such as argon (Ar), into a sealed space formed by the pair of sealing tools 10 so as to prevent oxidation of beads during pipe welding. The connection pipe 20 is disposed between the sealing tools 10, and the sealing tools 10 are fixed and coupled to either side end of the connection pipe 20. The connection pipe 20 includes a gas nozzle 22 that discharges or exhausts the inert gas transported from a gas tank 23 in which the inert gas is stored, into or from the sealed space formed by the sealing tools 10 and a cover 24 that is coupled to the sealing tools 10 in such a manner as to surround the outer circumferential surface of each of the sealing tools 10 and is formed of asbestos having a nonflammable property so as to prevent the sealing tools 10 from being damaged by heat generated during pipe welding.

The sealing tools 10 are fixed and coupled to either side end of the connection pipe 20. The connection pipe 20 may be formed of a material that is the same as or similar to the material used to form the sealing tools 10. That is, when the sealing tools 10 are formed of rubber, the connection pipe 20 is also formed of rubber so that the sealing tools 10 may be inserted into and coupled to the connection pipe 20 and then may be integrally fixed to the connection pipe 20 using thermal bonding.

The cover 24 has a cylindrical shape in which it is coupled to the connection pipe 20 in such a manner as to surround an outer surface of the connection pipe 20. The cover 24 blocks heat generated during pipe welding not to be directly transferred to the connection pipe 20 and prevents the connection pipe 20 from being damaged during usage.

Asbestos is mainly used as a fireproof material, an insulating material, or a heat insulating material, because it is resistant to acid and alkali and heat and fire. Asbestos is known as a material that causes lung cancer when it is inhaled and thus needs to be carefully used.

In the present invention, asbestos is used to constitute the connection pipe 20, but asbestos powder that causes disease is hardly generated, and there is no worry about occurrence of a problem caused by asbestos.

Since the connection pipe 20 configured as described above is disposed inside a portion in which the pipe P is to be welded, the connection pipe 20 is easily damaged by heat generated during welding. In the present invention, the connection pipe 20 is formed of asbestos having a nonflammable property and is prevented from being damaged by heat, and the gas nozzle 22 is disposed on an outer circumferential surface of the connection pipe 20 and supplies the inert gas into the pipe P or inhales the inert gas.

Unexplained reference numeral 25 is a discharge hole 25 through which the supplied inert gas is discharged to the outside. The discharge hole 25 communicates with the gas tank 23 disposed outside the pipe P via a pipe body, and the inert gas is inhaled and is discharged to the outside through the discharge hole 25 and the gas nozzle 22 described above.

Furthermore, a concentration sensor and a display unit that are generally used to supply and inspect gas may be further provided. The concentration sensor and the display unit have the same configuration and the same function as those of a currently-used concentration sensor and a display unit and thus, an additional description thereof will be omitted.

The air controlling portion 30 communicates with the sealing tools 10 and supplies or discharges air to or from the sealing tools 10. The air controlling portion 30 includes the air nozzles 32 disposed at the sealing tools 10 and an air supplying pipe 31 that communicates with the air nozzles 32 and transports air from the air tank 33 in which air is stored, to the air nozzles 32.

The air supplying pipe 31 serves as a passage of the air supplied via the air tank 33. The air nozzles 32 that communicate with and are coupled to the air supplying pipe 31 are respectively disposed at the sealing tools 10, discharge the supplied air into the sealing tools 10 to expand the sealing tools 10 or inhale the air to contract the sealing tools 10.

After a sensor (not shown) that checks the quantity of the supplied air is further provided, the sensor is connected to a regulating portion 34 or an external speaker (not shown) and prevents the sealing tools 10 from excessively expanding and bursting due to oversupply of the air, and a motor (not shown) that inhales external air and then transports the inhaled external air to the air supplying pipe 31 may be used instead of the air tank 33.

The flame retardant blocking layer 50 is coupled to each of the sealing tools 10 in such a manner as to surround the outer circumferential surface of each sealing tool 10 and prevents the sealing tool 10 that is in close contact with the inner wall of the pipe P from being damaged by heat generated during pipe welding. The flame retardant blocking layer 50 is formed of a flame retardant fiber which has elasticity and in which heat transferred from the outside is not easily propagated, so that the flame retardant blocking layer 50 may stretch simultaneously with the sealing tools that expand by the air supplied using the air controlling portion 30.

In this case, the flame retardant fiber used to form the flame retardant blocking layer 50 has a minimum limiting oxygen index (LOI) of 27 or more, and a representative example of the flame retardant fiber includes Kevlar that is mainly used to make heat-resistant clothes or bulletproof clothes.

The flame retardant fiber is burnt when a fiber product is in contact with a flame, but when the flame is removed, the flame retardant fiber prevents or suppresses the flame retardant fiber from being combusted while sparking. The flame retardant fiber is a fiber that does not make the fiber burnt but loses a fire propagation capability. The terms, such as “flameproof,” “fireproof,” and “smoke prevention,” are used instead of “flame retardant,” and the flame retardant fiber is mainly used for an interior material of a seat for a vehicle, a carpet, a non-woven cloth, and a wig.

The LOI that is a criterion for measuring combustibility is the lowest volume concentration of oxygen that may maintain combustion continuously when an inflammable material is disposed in a vertical direction and is ignited at the uppermost portion. The LOI is a new criterion for measuring a possibility that a combustion state will be maintained even after a fiber is first ignited and a heat source is removed, and a minimum LOI of 27 required in the present invention means that combustion does not continue after the heat source is removed if concentration of oxygen in the air is decreased to be equal to or less than 27%.

The flame retardant blocking layer 50 is coupled to each sealing tool 10 in such a manner as to surround the outer circumferential surface of each sealing tool 10, is disposed between the sealing tools 10 that expand by supply of air and the inner wall of the pipe P, prevents heat generated during pipe welding from being directly transferred to the sealing tools 10, thereby protecting the sealing tools 10 formed of a material that has elasticity and is vulnerable to heat, such as urethane or rubber.

In addition, the flame retardant blocking layer 50 may be coupled to each sealing tool 10 in such a manner as to surround the outer circumferential surface of each sealing tool 10 and one surface of a direction in which the pair of sealing tools 10 are adjacent. As illustrated in FIG. 2, the flame retardant blocking layer 50 is formed of a flame retardant fiber having elasticity and has an opening 51 in which one side of the flame retardant blocking layer 50 is opened. The flame retardant blocking layer 50 includes an elastic string 52 formed of rubber having a property in which the elastic string 52 is restored to its original position after being elasticized along an outer circumferential surface of the opening 51. The flame retardant blocking layer 50 increases the size of the opening 51 when the elastic string 52 stretches when the sealing tools 10 are covered with the elastic string 52, and after the sealing tools 10 are fully covered, the elastic string 52 is returned to its original position and is in close contact with sides of the sealing tools 10, thereby preventing the flame retardant blocking layer 50 from being peeled off from the sealing tools 10 during usage.

The flame retardant blocking layer 50 is formed of a flame retardant fiber having elasticity, stretches simultaneously with the sealing tools 10 that expand using the supplied air and is contracted simultaneously with the sealing tools 10 that are contracted.

In the present invention, a material for the flame retardant blocking layer 50 is Kevlar having a minimum LOI of 27 or more. Kevlar is a brand name of fiber developed by the Dupont (U.S.A) in 1971 that has a tensile strength that is 5 times that of iron (Fe) and an excellent heat-resisting property and is mainly used for abrasion-resisting material vehicle parts, a reinforced plastic material for an air plane, heatproof clothes, and bulletproof clothes.

In the present invention, Kevlar is used to form the flame retardant blocking layer 50. However, as described above, polybenzimidazole (PBI): poly[2,2-(m-phenylene)-5,5-benzimidazole] having a minimum LOI of 27 or more may be used.

The flame retardant blocking layer 50 is coupled to each sealing tool 10 in such a manner as to surround the entire outer circumferential surface of each sealing tool 10 and prevents the sealing tools 10 from being damaged by heat generated during welding and simultaneously, the flame retardant blocking layer 50 is detachably coupled to each sealing tool 10 so that a flame retardant blocking layer 50 damaged by heat may be easily replaced with another one.

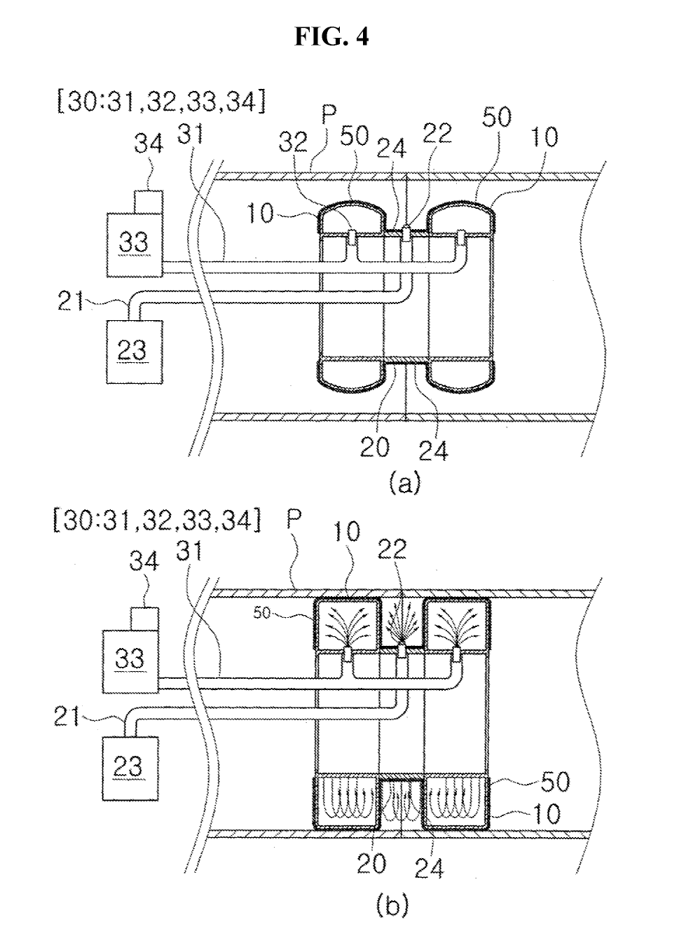

A usage state of the purging device for pipe welding having the above configuration according to the present invention will now be described with reference to FIG. 4.

First, the sealing tools 10 are disposed inside a pipe to be welded. The sealing tools 10 are disposed at right and left sides of a portion to be welded. The sealing tools 10 expand by supplying air stored in the air tank 33 to the sealing tools 10 using the air controlling portion 30, are in close contact with the inner wall of the pipe P and block the portion to be welded to be sealed from the outside.

Subsequently, after an inert gas stored in the gas tank 23 is transported via a gas supplying pipe 21, the gas nozzle 22 discharges the inert gas to the outside, and the sealed space formed by the sealing tools 10 is filled with the inert gas and then the pipe P is welded from the outside.

In this case, the flame retardant blocking layer 50 fixed to each sealing tool 10 is disposed between the sealing tool 10 and the inner wall of the pipe P and prevents heat generated during welding from being directly transferred to the sealing tools 10, thereby protecting the sealing tools 10 from heat, and the connection pipe 20 is formed of asbestos having a nonflammable property and is protected from heat.

Subsequently, the inert gas supplied into the pipe P after welding of the pipe P is finished, is inhaled through the gas nozzle 22 of the connection pipe 20 and the discharge hole 25 and then is discharged to the outside and then a worker enters an inside of the pipe P or checks a welded portion using a camera.

Thus, the sealing tools 10 and the connection pipe 20 are protected and are prevented from being damaged by heat generated during pipe welding, and the flame retardant blocking layer 50 is detachably coupled to each sealing tool 10 so that a flame retardant blocking layer 50 damaged during usage may be easily replaced with another one, and the connection pipe 20 is formed of asbestos having a nonflammable property, or the cover 24 formed of asbestos is coupled to the connection pipe 20 in such a manner as to surround an outer circumferential surface of the connection pipe 20 so that maintenance can be facilitated.

While the invention has been shown and described with reference to certain exemplary embodiments thereof, it will be understood by those skilled in the art that various changes in form and details may be made therein without departing from the spirit and scope of the invention as defined by the appended claims.

1. A purging device for pipe welding, comprising:
a pair of sealing tools 10 that are disposed inside a pipe P, expand by supplied air and are in contact with an inner wall of the pipe P; and
a connection pipe 20 that is disposed between the pair of sealing tools 10, is a cylindrical body, wherein the sealing tools 10 are respectively fixed to either side end of the connection pipe 20 and the connection pipe 20 is provided with a gas nozzle 22 for discharging inert gas supplied from the outside,
wherein each of the sealing tools 10 further comprises a blocking layer 50 that is flame retardant and is coupled in such a manner as to surround an outer circumferential surface of each of the sealing tools 10.

2. The purging device of claim 1, wherein the flame retardant blocking layer 50 is formed of a flame retardant fiber which has elasticity and in which heat transferred from the outside is not easily propagated, so that the flame retardant blocking layer 50 stretches simultaneously with the sealing tools 10 that expand by supply of air.

3. The purging device for pipe welding of claim 2, wherein the flame retardant blocking layer 50 is formed of Kevlar having a minimum limiting oxygen index (LOI) of 27 or more.

4. The purging device for pipe welding of claim 2, wherein the flame retardant blocking layer 50 comprises an opening 51 in which one side of the flame retardant blocking layer 50 is opened, and an elastic string 52 formed of an elastic material along an outer circumferential surface of the opening 51.

5. The purging device for pipe welding of claim 1, wherein the connection pipe 20 further comprises a cover 24 formed of asbestos having a nonflammable property so as to prevent the sealing tools 10 from being damaged by heat generated during pipe welding.

6. The purging device for pipe welding of claim 1, wherein the connection pipe 20 further includes a discharge hole 25 through which the inert gas supplied is discharged to the outside.

7. The purging device for pipe welding of claim 2, wherein the connection pipe 20 further includes a discharge hole 25 through which the inert gas supplied is discharged to the outside.

8. The purging device for pipe welding of claim 3, wherein the connection pipe 20 further includes a discharge hole 25 through which the inert gas supplied is discharged to the outside.

9. The purging device for pipe welding of claim 4, wherein the connection pipe 20 further includes a discharge hole 25 through which the inert gas supplied is discharged to the outside.

10. The purging device for pipe welding of claim 5, wherein the connection pipe 20 further includes a discharge hole 25 through which the inert gas supplied is discharged to the outside.
